(19) United States
(12) Patent Application Publication
(10) Pub. No.: US 2024/0079915 A1
(43) Pub. Date: Mar. 7, 2024

(54) CHARGER FOR A PERSONAL CARE DEVICE

(71) Applicant: Braun GmbH, Kronberg (DE)

(72) Inventors: Torsten KLEMM, Eschborn (DE); Manal ALI, Frankfurt am Main (DE); Matthew Lloyd NEWMAN, Oberursel (DE); Li CHI HUNG, Hong Kong (CN); Jose Nino Marasigan SURLA, Shenzhen (CN); Jiang ZHAO BING, Shenzhen (CN)

(21) Appl. No.: 18/455,850

(22) Filed: Aug. 25, 2023

(30) Foreign Application Priority Data
Sep. 2, 2022 (WO) PCT/CN2022/116729

(51) Int. Cl. H02J 50/90; H02J 7/00

(52) U.S. Cl. CPC H02J 50/90; H02J 7/0071; H02J 2310/22

(57) ABSTRACT

A charger for wireless energy transfer to a personal care device has a travel mode and an internal energy storage, a sensor for detecting a change of position of the charger, and a processor coupled with the sensor for receiving sensor signals relating to a detected change of position of the charger. The processor is arranged to: start a first timer if a change of position is detected by the sensor, the first timer set to run for a first predetermined period, increase a first counter if a change of position is detected by the sensor while the first timer is running, compare a value of the first counter with a first threshold value at the end of the first predetermined period or with a first range having a first lower range value and a first upper range value, and enter the travel mode in case the value of first counter is at or above the first threshold value or is within the first range, wherein the travel mode includes that the processor is arranged to set the charger into an energy saving state for a predetermined travel mode period.

### FIELD OF THE INVENTION

The present application is concerned with a charger having an internal energy source, a sensor that is arranged to detect a motion or vibration of the charger, and a mode in which the charger consumes less energy than in a regular or standard mode.

### BACKGROUND OF THE INVENTION

A charger comprising an internal energy source for charging a personal device when the user has no access to a standard mains connection is generally known. It is also known that such a charger, often also called a power bank, can transmit the energy in a wireless manner, e.g., via inductive charging.

To initiate the charging procedure, the charger may regularly check whether a personal device to be charged is put onto the charger. This regular check consumes energy. In particular in case the user travels, and the charger is stored in the travel luggage, it is not to be expected that a personal device to be charged will be put onto the charger. Energy for the regular check reduces the amount of energy available in the internal energy source for the actual charging procedure.

This disclosure provides a charger with an internal energy source that consumes less energy during periods without actual charging.

### SUMMARY OF THE INVENTION

In accordance with at least one aspect, a charger is provided that is structured and arranged for wireless energy transfer to a personal care device, the charger having a travel mode and comprises an internal energy storage, a sensor for detecting a change of position of the charger, preferably a motion or vibration sensor, a processor being coupled with the sensor for receiving sensor signals relating to a detected change of position of the charger, preferably a detected motion or vibration of the charger, and the processor being arranged to start a first timer if a change of position is detected by the sensor, the first timer set to run for a first predetermined period, to increase a first counter if a change of position is detected by the sensor while the first timer is running, to compare a value of the first counter with a first threshold value at the end of the first predetermined period or with a first range having a first lower range value and a first upper range value, and to enter the travel mode in case the value of first counter is at or above the first threshold value or is within the first range, where the travel mode comprises that the processor is arranged to set the charger into an energy saving state for a predetermined travel mode period.

In accordance with at least one aspect, a charger is provided that is structured and arranged for wireless energy transfer to a personal care device, the charger having a travel mode and comprises an internal energy storage, a sensor for detecting a change of position of the charger, preferably a motion or vibration sensor, a processor being coupled with the sensor for receiving sensor signals relating to a detected change of position of the charger, preferably a detected motion or vibration of the charger, and the processor being arranged to start a first timer if a change of position is detected by the sensor, the first timer set to run for a first predetermined period, to increase a first counter if a change of position is detected by the sensor while the first timer is running, to compare a value of the first counter with a first threshold value at the end of the first predetermined period, to start a second timer if the value of the first counter is at or above the first threshold value, the second timer set to run for a second predetermined period, to increase a second counter if a change of position is sensed by the sensor while the second timer is running, to compare a value of the second counter with a second threshold value or with a second range having a second lower range value and a second upper range value at the end of the second predetermined period, and to enter the travel mode in case the value of the second counter is at or above the second threshold value, where the travel mode comprises that the processor is arranged to set the charger into an energy saving state for a predetermined travel mode period.

### BRIEF DESCRIPTION OF THE DRAWINGS

The present disclosure will be further elucidated by a detailed description of example embodiments and with reference to figures. In the figures

FIG. 1 is a schematic depiction of a charger in accordance with the present disclosure;

FIG. 2 is a schematic depiction of a process flow in accordance with a first example method of setting a charger into a travel mode; and

FIG. 3 is a schematic depiction of a process flow in accordance with a second example method of setting a charger into a travel mode.

### DETAILED DESCRIPTION OF THE INVENTION

A charger in accordance with the present disclosure comprises an internal energy source that can be used to charge a rechargeable energy source of a device, such as a personal device or a personal care device, e.g., an electric toothbrush, an electric shaver or razor, an electric epilator, an electric massage device etc. The charging procedure may comprise wireless energy transfer from the charger to the device, e.g., via an inductive charging procedure or a resonance charging procedure. The charger may further have an input or a cable for connection with a mains supply or with another external energy supply. In case the charger receives energy from an external energy supply such as mains supply, the internal energy source may not be used for charging a device and/or the internal energy source may itself be charged. The charger may additionally or alternatively have an output or a cable for wired charging of a device. The charger has a sensor for detecting a change of state of position of the charger, which shall mean that the sensor is sensible to a change of position of the sensor itself. The sensor may be fixedly attached to at least a portion of the housing of the charger or to a support that itself may be fixedly mounted with respect to at least a portion of the housing of the charger.

The sensor may be of a type that is arranged to detect a motion from a rest state to a non-rest state, i.e., the motion comprising an acceleration, or a vibration of the charger or of at least of a portion of a housing of the charger to which the sensor is attached, e.g., the sensor being an accelerometer and/or a gyroscope and/or a vibration switch such as a mechanical vibration switch. The sensor may than have at least one axis along which the motion or vibration is determined or the sensor may have two or three axes along which the motion or vibration is measured. The sensor may alternatively or additionally be realized as or comprise a magnetometer.

The sensor may alternatively or additionally be realized as or comprise a barometric sensor arranged to detect a change of the air pressure and thus a change of the altitude of the charger. The sensor may alternatively or additionally be realized as or comprise a GPS receiver, even though the latter may be considered relatively expensive. The sensor is typically coupled with a processor so that the processor can receive sensor signals that carry sensor data indicative of the detected sensor value or sensor values. The sensor may be structured and/or arranged to output sensor signals that carry sensor data being indicative of detected motion or vibration.

The processor is arranged to receive the sensor signals and to analyze the sensor data to determine whether a travel mode of the charger is to be switched on. The sensor data may be indicative of the charger changing its position due to a continuous or repetitive detection of motion and/or vibration and/or altitude changes or changes in the magnetic field or the like. For sake of simplicity, it is in the following only referred to motion and vibration. It shall be understood that motion and vibration of the charger are positional changes. In the latter case, a vibration may be considered a small periodic positional change, often around a center point of vibration and the vibration may stop or cease after a portion of a vibration cycle or after a plurality of vibration cycles.

A vibration may have an amplitude in the micrometer regime, e.g., in a range of between 1 micrometer and 1000 micrometer. A motion may be a positional change where the charger is at one position in space at one point in time and at another position in space at another point in time. The motion distance may be small, e.g., when a device to be charged is put onto the charger, the charger may move a fraction of a millimeter or some millimeters, or may be large, e.g., when the charger is taken by a travelling user and the motion distance may then amount to several thousand kilometers.

A charger intended for charging of a device, preferably of a personal care device such as an electric toothbrush may be located on a bathroom sink or the like. The charger may experience certain low amplitude positional changes due to vibrations of the house in which the bathroom is located or due to vibrations of the bathroom or of the bathroom sink due to people walking around. The processor may be arranged to ignore such low-level vibrations or motions, e.g., by applying a threshold value for the signal value by which such low-level noise on the signal can be removed, i.e., only a signal value above the threshold value would then be taken into account as a motion or vibration. Such “serious” motion or vibration may be caused by the user putting a personal care device onto the charger.

A mechanical vibration switch or inertia switch may avoid vibrational noise by design, i.e., the mechanical vibration switch may only be triggered in case the motion, vibration or shock is above a certain threshold level. In the following it shall be understood that reference made to a detected motion or vibration means the detection of a serious motion or vibration, i.e., a motion or vibration being above a noise level. The skilled person understands that the noise-related threshold value can be set based on the measurements of noise and of serious motions and vibrations in dependence on the specific sensor that is used.

A serious motion or vibration may be caused by a user putting a device onto the charger for charging or lifting a device off from the charger. The threshold value to be applied may then be set to be in the center between the noise level and the average motion or vibration signal caused by putting a device onto the charger, e.g., a plurality of measurements with a plurality of users and/or a plurality of devices may be performed to determine the average motion. The threshold value should preferably be set such that the noise does not trigger a motion or vibration signal but that putting any device onto the charger by any user is recognized as a motion or vibration event.

In accordance with some aspects, the processor may be arranged to check whether a device to be charged was put onto the charger when the sensor provides a sensor signal indicative of a motion or vibration. The processor may then trigger a primary side charging circuit of the charger to wirelessly provide energy and to analyze whether the provided energy is utilized. This provision of energy leads to energy loss. If the energy is taken from the internal energy source of the charger, the capacity available for charging a rechargeable energy source of a device to be charged by the charger is reduced. If the charger is carried along for some travel, the sensor may constantly or at least repetitively provide a sensor signal indicative of a motion or vibration and the charger would then constantly or at least repetitively trigger the charging circuit to provide energy to a potential personal care device to be charged during the travel period.

In accordance with at least some aspects, the processor is arranged to detect that the sensor signals provided by the sensor are indicative of the charger being travelling. The charger is then set into a travel mode in which the charger consumes less energy than in its regular or normal mode. The travel mode may comprise that the processor omits every other sensor signal indicating a motion or vibration or that nine out of ten such sensor signals are ignored or that the sensor signals are ignored for a predetermined travel mode time period and that the processor does not trigger the charging circuit to provide energy via the primary side charging circuit during this period.

In some embodiments, the travel mode includes that the charger is essentially completely shut down and can then only be reactivated by an interrupt, which may be generated by a user-operable input element. In the latter case, the predetermined travel mode time period is indefinitely long. One may also say that in the latter case the processor is arranged to put the charger into a travel mode from which the charger can only be awakened by operation of a user-operable input element.

The processor may determine that the charger is travelling in case that the number of motions or vibrations detected within a first predetermined period is at or above a first threshold value. The processor may start a first timer if the processor determines that a received sensor signal is indicative of a motion or vibration, which first timer may run for the first predetermined period, e.g., one minute or two minutes or 30 seconds or five minutes etc. The processor may then count the number of detections of motions and/or vibrations based on the received sensor signals and the processor may then compare the number of detected motions and/or vibration at the end of the first predetermined period with the first threshold value.

In case the number of detected motions and/or vibrations is at or above the first threshold value, the processor may initiate the travel mode. In case the number of detected motions and/or vibrations is below the first threshold value, the processor may reset the number of detected motions and/or vibration, e.g., reset the number to 0, and may restart the first timer to run for the first predetermined period once a next motion and/or vibration signal is detected.

The first threshold value for a first predetermined period of one minute may have any value in a range of between 2 and 50, e.g., 2 or 5 or 10 or 15 or 20 or 22 or 25 or 27 or 30 or 40 or 44 or 48 or 50. But it shall be understood that these values depend on the sensor type and the time period during which the number of motions or vibrations are detected and the skilled person may determine the relevant number of motion events by doing measurements as are explained below.

Experiments have been performed under various circumstances and the particular situation or motion scenario, and the number of detected motions or vibrations in such a scenario is shown in the below table. The numbers are understood to be qualitative and indicate differences between different situations.

Based on the below table, the first threshold value may be set to about 20 to differentiate between non-travelling situations (e.g., charger is moved around by hand) and travelling situations. Instead of just a first threshold value, the number of detected motions during, e.g., one minute, may be required to be within a first range such as in a range of between 20 and 250, to differentiate non-travelling situations and artificial motion detection (e.g., due to tapping or the like) from travelling situations.

A first lower range value may then be the first threshold value and a first upper range value would be another value by which a non-travelling situation causing a high number of motion detections are split off from the first range, e.g., 250 or 260 or 270 or 280 or 290 or 300 etc. The check done by the processor would then include to check whether the number of detected motions during the first predetermined period is at or above the first lower range value (being the first threshold value) and is below the first upper range value.

| | Number of |
|---|---|
| | detected |
| Motion Scenario | motions |
| Charger put in pocket of a person and person walks for one | 31 |
| minute | |
| Charger put in pocket of a person and person walks for two | 51 |
| minutes | |
| Charger put into a trolley and moved for one minute | 242 |
| Charger put into a trolley and moved for two minutes | 537 |
| Charger taken in the hand of a person and moved 5 meters | 11 |
| Charger taken in the hand of a person and moved 20 meters | 12 |
| Charger is continuously tapped for one minute | 707 |

In accordance with some aspects, the processor may start a second timer that runs for a second predetermined period if the number of detected motions and/or vibrations during the first predetermined period is at or above the first threshold value or is within the first range. The processor may then be arranged to count the number of detected motions or vibrations during the second predetermined period and may initiate the travel mode if the number of detected motions during the second predetermined period is at or above a second threshold value or is within a second range having a second lower range value that may be identical with the second threshold value and a second upper range value, which may be a value above the second threshold value, e.g., the mentioned range values of 20 and 250 may be applied again for the second range in case the first and second predetermined periods are identical in length (in case of non-identical length, the threshold value and/or the range values may be adapted by simple scaling).

With respect to the second timer, it was found that it may provide a more detailed view onto the temporal behavior of the motion of the charger if, e.g., instead of only a first two-minute timer, two one-minute timer are used as it can then better be derived whether a certain number of motions is detected in the first minute and also in the second minute. A high number of tapping motion events in the first minute that is followed by essentially no motion is the second minute may lead to switching on of the travel mode while the charger is indeed not travelling. Of course, instead of two successive timer periods also three or more timer periods could be used, e.g., four thirty second timer periods or three one-minute timer periods etc. There may be thus a third timer after the second timer and also a fourth timer after the third timer etc.

Generally, the first or second lower range values or the first or second threshold values may be in a range of between 2 and 50 and the first or second upper range value may be in a range of between 150 to 500 for a timer period of one minute and may be respectively scaled for other period lengths, e.g., the first or second lower range values or the first or second threshold values may be in a range of between 4 and 100 for a first or second predetermined period of two minutes length.

The processor may be arranged to inhibit that the charger enters the travel mode at least in case that one of the following is true:
a personal care device is present on the charger;
the charger is currently charging a device;
the charger is connected with an external energy supply such as mains supply; and
a device to be charged is put onto the charger while the first or the second timer are running.

The presence of the personal care device or a device in general may be determined by checking whether a wireless charging circuit can be established, i.e., by determining whether or not the device requires charging. Additionally or alternatively, the charger may comprise a presence sensor such as a mechanical switch that is closed by the device or a capacitive sensor or the like.

In addition to what is discussed above, the charger may also comprise at least one of the following:
a user-operable input element, e.g., a switch, a button, a touch-sensitive element, a user interface, a graphical user interface or the like, to switch off the travel mode; and
a user-operable input element, e.g., a switch, a button, a touch-sensitive element, a user interface, a graphical user interface or the like, to switch on the travel mode.

The user-operable input elements may be realized as a single element, e.g., an on/off button.

The user-operable input element(s) may additionally or alternatively be provided by a separate device, e.g., a proprietary separate device, a mobile phone, tablet, notebook, laptop, personal computer, smart watch etc., that is in data communication with the charger. The charger and the separate device may be connected by a wired or a wireless connection. The separate device may comprise a display and an App running on a processor of the separate device to provide a graphical user interface so that the user can at least switch off and/or switch on the travel mode using a touch sensitive button of the graphical user interface. The separate device may of course comprise at least one mechanical switch or button to realize at least one of the user-operable input elements.

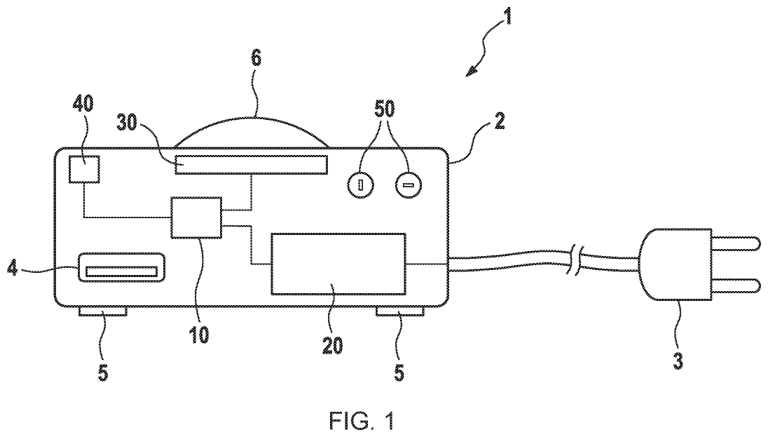

FIG. 1 is a schematic depiction of a charger 1 in accordance with the present disclosure. The charger 1 is understood to be structured and arranged for wireless energy transfer to a device such as a personal care device, e.g., by means of inductive charging or resonance charging. The charger may have a housing 2, a wired connector 3 allowing connection with a mains supply, an input 4 for allowing wired charging of a device, a foot or feet 5 for standing on a ground, and/or a housing elevation (as shown) or depression 6 that is intended for a positive fit type of mechanical cooperation with a respective indentation or elevation of a device to be charged.

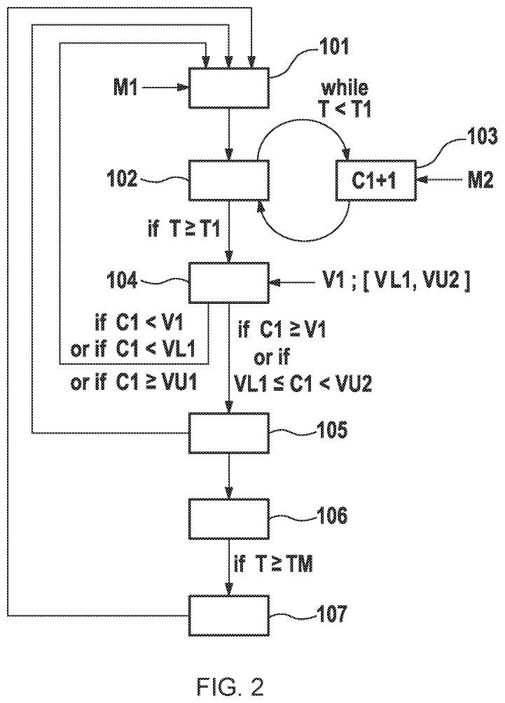

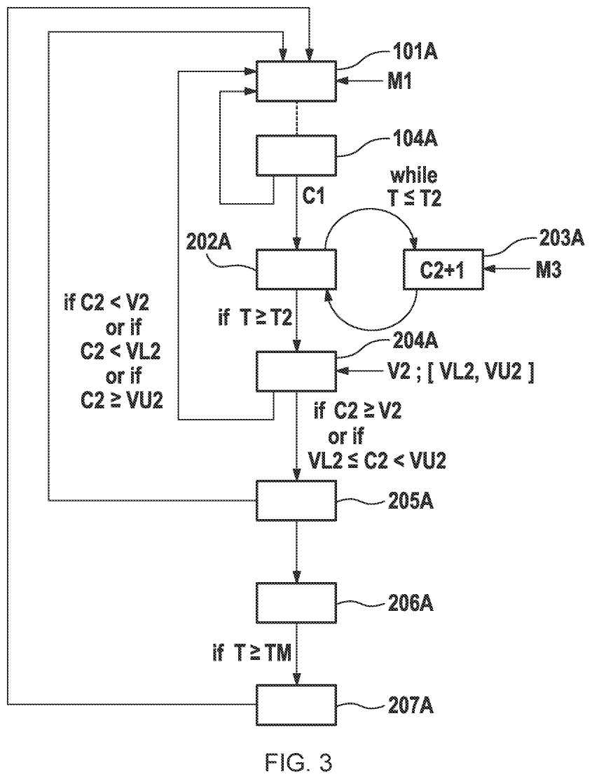

The connector 3 may be detachable. Instead of the input 4, a cable may be provided for wired charging. The charger 1 may comprise a processor 10, an internal energy storage 20, a primary side charging circuit 30, a sensor 40 for detecting a positional change of the charger 1 and/or one or several user-operable input elements 50 for switching on or off a travel mode or for switching on or off the charger 1 itself. The sensor 40 may be realized as one of the sensors previously mentioned. The processor 10 may be structured and/or arranged to perform the previously discussed steps to determine whether the charger 1 is to enter a travel mode. This is also discussed with reference to FIGS. 2 and 3 in the following.

FIG. 2 is a schematic depiction of process steps in accordance with at least some aspects relating to deciding whether a charger is to enter a charging mode, which process steps may be implemented on the processor of the charger.

At process step 101, the processor waits for a sensor signal M1 to be received from a sensor for detecting a positional change of the charger, the signal M1 being indicative of a detected positional change such as a motion or vibration. If the processor receives the sensor signal M1 that indicates a positional change of the charger, the processor starts a first timer and continues at process step 102, which continues as long as a timer value T indicating the time passed since starting the first timer is below a first predetermined period T1. While the first timer runs in process step 102, the processor monitors whether a signal M2 from the sensor indicates a positional change of the charger and increases a counter C1 at process step 103 if such a sensor signal M2 is received.

The counter C1 may initially be set to 0 or 1. In case that the time T passed since starting the first timer is at or above the first predetermined period T1, the processor enters into process step 104, where the counter value C1 is compared with a first threshold value V1 or with a first range having a first lower range value VL1 and a first upper range value VU2. In case that the first counter value C1 is lower than the first threshold value V1 or the first counter value C1 is lower than the first lower range value VL1 or is at or above the first upper threshold value VU1 then the process starts again at process step 101. If the first counter value C1 is above the first threshold value V1 or is at or above the first lower range value VL1 and is below the first upper range value VU2 then the process may enter process step 105, where the processor may check whether the charger is currently connected with an external energy supply or whether a device is currently present or is being charged.

If any such condition is fulfilled, the process returns to process step 101. Otherwise, the processor sets the charger into a travel mode for a predetermined travel mode period TM, where the charger consumes less energy in the travel mode than in the regular mode, in particular where the charger does not check whether any device to be charged is put onto the charger, specifically as the charger does not monitor the sensor that indicates a positional change of the charger. The predetermined travel mode period may be set to any suitable time, e.g., one hour or two hours or three hours or five hours or six hours or one day etc.

It is obvious that in case of prolonged travelling, the charger will be set into travel mode again due to continuous positional change signals, hence it may suffice to set the predetermined travel mode period TM to a short time such as one hour or two hours. If the time T passed since the start of the travel mode is at or above the predetermined travel mode period TM, the charger is awakened from the travel mode at process step 107 and enters into process step 101 again. Alternatively to setting the charger into the travel mode for a predetermined travel mode period, the processor may completely shut down the charger so that it can only be awakened by an interrupt signal, which may be provided by a user-operable input element.

FIG. 3 is a schematic depiction of process steps in accordance with at least some aspects, which process steps may be implemented on the processor of the charger. Specifically, the process steps in accordance with FIG. 3 comprise a second timer as will be explained in the following.

The process flow of FIG. 3 is intended to start as described for FIG. 2. The process steps 101A and 104A shall be the same as process steps 101 and 104 as discussed in connection with FIG. 2, where is shall be understood that process steps 102 and 103 are occurring here as well but have been omitted in FIG. 3 for sake of simplicity of the depiction. In contrast to the process flow after process step 104 as discussed with reference to FIG. 2, the process step 104A leads to the start of a second timer running for a second predetermined period at process step 202A as a consequence of the comparison of the first counter C1 with the first threshold value or with the first range, where the second timer is started at 202A in case that the first counter C1 is at or above the first threshold value or is at or above the first lower range value and is below the first upper range value as was described above for FIG. 2. Similarly, as was explained for process steps 102 and 103, the processor is then structured and/or arranged to monitor whether a signal M3 from the sensor is indicating a motion or vibration of the charger at process step 203A.

A second counter C2 that may initially be set to 0 may then be incrementally increased by 1 in case that a signal M3 indicating a motion or vibration of the charger is received while the second timer is running during the second predetermined period. Once the time T passed since the start of the second timer is at or above the second predetermined period T2, the process enters process step 204A, where a second threshold value V2 and/or a second range determined by a second lower threshold value VL2 and a second upper threshold value VU2 are provided for comparison with the second counter C2. In case that the second counter C2 is below the second threshold value V2 or is below the second lower threshold value VL2 or is at or above the second upper threshold value VU2, the process goes back to the start process step 101A, where the processor monitors whether a signal M1 from the sensor indicates a motion or vibration that would start the whole process again.

In case that the result of the comparison done at process step 204A is that the second counter C2 is at or above the second threshold value V2 or the second counter C2 is at or above the second lower threshold value VL2 and below the second upper threshold value VU2, the process enters process step 205A, where the processor may check whether the charger is currently connected with an external energy supply or whether a device is currently present or is being charged. If any such condition is fulfilled, the process returns to process step 101A. Otherwise, the processor sets the charger into the travel mode for a predetermined travel mode period TM at process step 206A, where the charger consumes less energy in the travel mode than in the regular mode, in particular where the charger does not check whether any device to be charged is put onto the charger, specifically as the charger does not monitor the sensor that indicates a positional change of the charger.

If the time T passed since the start of the travel mode is at or above the predetermined travel mode period TM, the charger is awakened from the travel mode at process step 207A and enters process step 101A again. These latter steps are again identical to what was described for process steps 105, 106 and 107 with respect to FIG. 2. The difference between the processes described with respect to FIGS. 2 and 3 is that in FIG. 3, the process includes the second timer after the first timer as was previously described in general terms.

As has been indicated, the process flow may include a third timer and even one or several further timers is such are considered as necessary. Again, alternatively to setting the charger into the travel mode for a predetermined travel mode period, the processor may completely shut down the charger so that it can only be awakened by an interrupt signal, which may be provided by a user-operable input element.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A charger structured and arranged for wireless energy transfer to a personal care device, the charger having a travel mode and comprises:
an internal energy storage;
a sensor for detecting a change of position of the charger; and
a processor coupled with the sensor for receiving sensor signals relating to a detected change of position of the charger, the processor being arranged to:
start a first timer if a change of position is detected by the sensor, the first timer set to run for a first predetermined period,
increase a first counter if a change of position is detected by the sensor while the first timer is running,
compare a value of the first counter with a first threshold value at the end of the first predetermined period or with a first range having a first lower range value and a first upper range value, and
enter the travel mode in case the value of first counter is at or above the first threshold value or is within the first range, where the travel mode comprises that the processor is arranged to set the charger into an energy saving state for a predetermined travel mode period.

2. A charger structured and arranged for wireless energy transfer to a personal care device, the charger having a travel mode and comprises:
an internal energy storage;
a sensor for detecting a change of position of the charger; and
a processor coupled with the sensor for receiving sensor signals relating to a detected change of position of the charger, the processor being arranged to:
start a first timer if a change of position is detected by the sensor, the first timer set to run for a first predetermined period,
increase a first counter if a change of position is detected by the sensor while the first timer is running,
compare a value of the first counter with a first threshold value or with a first range having a first lower range value and a first upper range value at the end of the first predetermined period,
start a second timer if the value of the first counter is at or above the first threshold value or is within the first range, the second timer set to run for a second predetermined period,
increase a second counter if a change of position is sensed by the sensor while the second timer is running,
compare a value of the second counter with a second threshold value or with a second range having a second lower range value and a second upper range value at the end of the second predetermined period, and
enter the travel mode in case the value of the second counter is at or above the second threshold value or within the second range, where the travel mode comprises that the processor is arranged to set the charger into an energy saving state for a predetermined travel mode period.

3. The charger of claim 1, wherein the processor is arranged to inhibit entering the travel mode in case a personal care device is currently being charged by the charger.

4. The charger of claim 1, wherein the processor is arranged to inhibit entering the travel mode in case the charger is currently connected with an external energy supply.

5. The charger of claim 1, wherein the first threshold value is in a range of between 2 and 50 for a first predetermined period having a length of one minute and/or wherein the first lower range value is in a range of between 2 and 50 for a first predetermined period having a length of one minute and the first upper range value is in a range of between 150 and 300 for a first predetermined period having a length of one minute.

6. The charger of claim 2, wherein the second threshold value is in a range of between 2 and 50 for a second predetermined period having a length of one minute and/or wherein the second lower range value is in a range of between 2 and 50 for a second predetermined period having a length of one minute and the second upper range value is in a range of between 150 and 300 for a second predetermined period having a length of one minute.

7. The charger of claim 1, wherein the first predetermined period is in a range of between 5 seconds and 10 minutes.

8. The charger of claim 2, wherein the second predetermined period is in a range of between seconds and 10 minutes.

9. The charger of claim 1, wherein the sensor is an accelerometer.

10. The charger of claim 1, wherein the sensor is a vibration switch.

11. The charger of claim 1, wherein the predetermined travel mode period is in a range of between 30 minutes and 24 hours.

12. The charger of claim 1, wherein the charger comprises a user-operable input element for switching off the travel mode.

13. The charger of claim 1, wherein the charger comprises a user-operable input element for switching on the travel mode.

14. The charger of claim 1, wherein the processor is arranged to stop the first timer in case charging of a personal care device is started while the first timer is running.

15. The charger of claim 2, wherein the processor is arranged to stop the second timer in case charging of a personal care device is started while the second timer is running.

16. The charger of claim 1, wherein the sensor for detecting a change of position of the charger comprises a motion sensor or a vibration sensor.

17. The charger of claim 1, wherein the sensor is selected from a motion sensor and a vibration sensor.

18. The charger of claim 1, wherein the detected change of position of the charger is a detected motion or vibration of the charger.

19. The charger of claim 2, wherein the sensor is selected from a motion sensor and a vibration sensor.
